(19) United States
(12) Patent Application Publication
(10) Pub. No.: US 2006/0198520 A1
(43) Pub. Date: Sep. 7, 2006

(54) Secure transmission of digital audio signals

(76) Inventors: Peter Courtney, Kent (GB); Christopher White, Twickenham (GB); Andrew John Baker, Hertfordshire (GB)

Correspondence Address: Edward J. Russavage;Lowrie, Lando & Anastasi, LLP, One Main Street, Cambridge, MA, 02142, US

(21) Appl. No.: 10/631,674

(22) Filed: Jul. 31, 2003

(30) Foreign Application Priority Data
Dec. 20, 2002 (GB) 0229781.0
Jun. 12, 2003 (GB) 0313658.7

(51) Int. Cl. H04K 1/00

(52) U.S. Cl. 380/247

(57) ABSTRACT

In a headset audio speech signals are picked up by the microphone, where they are digitally sampled before being encoded by a vocoder. The coded speech data is then provided to a CRC module, where error correction data is added before the resulting data is encrypted by an encryption module. The resulting encrypted data is transmitted using a Bluetooth radio interface, by which the headset is connected wirelessly to a mobile telephone. Received data is decrypted by a decryption module, error corrected by an error correction module and decoded by a decoder, with the resulting audio signals then being reproduced at a speaker. When a user wants to instigate a telephone call with another telephone, the headset is caused to send a control signal to the mobile telephone instructing it to enter a data mode. A data call is then set up and, once established, the CPU controls the setting up of a 128 bit encryption key which is subsequently used for communications between the headset and a corresponding device associated with the recipient of the call. Encryption and decryption are performed only at the headset. This provides increased security since even if the call can be intercepted, the interceptor will need to decrypt the signals before being able to reproduce the audio signals.

### FIELD OF THE INVENTION

This invention relates generally to secure communications, and more specifically, to methods for securing audio information.

### BACKGROUND OF THE INVENTION

Although it is relatively common for transmissions between a mobile telephone and a base station to be encrypted so as to make difficult the eavesdropping of telephone conversations with a suitable radio receiver, encryption is not normally used with signals upwards of the base station. If a person had access to call signals as they were carried over, for example, a public switched telephone network (PSTN) or an integrated services digital network (ISDN), it would be fairly straightforward to reproduce the audio signals forming the call without disrupting the call.

### SUMMARY OF THE INVENTION

According to one aspect of the present invention, an apparatus and method is provided for improving security for audio communications made over a communications network. Various aspects of the present invention relate generally to an audio interface device, which can sample and encrypt audio signals or signals derived from audio signals before providing them for transmission from a telephone over a data channel. Other aspects of the invention relate to an audio interface device which can sample and code audio signals or signals derived from audio signals before providing them for transmission from a telephone over a data channel. Other aspects of the invention relate also to corresponding methods of operating an audio interface device, to corresponding methods of transmitting encrypted audio signals, and to corresponding system including an audio interface device and a telephone Other aspects of the invention relate generally to a method of communicating between first and second devices including sending an encrypted session key to the second device, and to a communication device comprising means for encrypting a session key, and for sending the encrypted session key.

According to a first aspect of the invention, there is provided an audio interface device operable to provide a signal for controlling a telephone to communicate with a network via a data channel, and to sample and encrypt audio signals or signals derived therefrom before providing them for transmission over the data channel.

In one embodiment, the telephone is a cellular or mobile telephone (the terms are used interchangeably in this specification).

In a preferred embodiment, the device comprises a coder arranged to code the audio signals before providing them for transmission, and a controller that adds error correction data to the audio signals or the signals derived therefrom, as the case may be, before providing them for transmission. If encryption is effected using a Diffie- Hellman algorithm, good security can be effected without requiring the safe transmission of an encryption key over a secure channel.

To allow the device to act as a two-way interface, it preferably comprises a receiver that receives encrypted signals from the telephone, and decrypts them before reproducing them as audio signals. To handle decoded signals, the device may comprise a decoder that decodes the decrypted signals before reproduction. Resilience to interference on the channel between the telephone and a source of received encrypted data can be provided by error correcting the decrypted signals.

According to a second aspect of the invention, there is provided a method of operating an audio interface device, the method comprising acts of controlling the device to provide a signal for controlling a telephone (and in one embodiment, a mobile telephone) to communicate with a network via a data channel, controlling the device to sample and to encrypt audio signals or signals derived therefrom and controlling the device to provide the encrypted signals for transmission over the data channel.

According to a third aspect of the invention, there is provided a method of transmitting encrypted audio signals, the method comprising acts of controlling a mobile telephone to communicate with a network via a data channel, sampling audio signals, encrypting the samples or data derived from the samples, and providing the encrypted data for transmission over the data channel.

According to a fourth aspect of the invention, there is provided a system comprising an audio interface device and a telephone, the audio interface device being operable to provide a control signal for controlling the telephone to communicate via a data channel, and to sample and encrypt audio signals or signals derived therefrom before providing them to the telephone, the telephone being responsive to receiving the control signal for communication with a network via a data channel, and for transmitting the encrypted audio signals over the data channel.

According to a fifth aspect of the invention, there is provided an audio interface device operable to provide a signal for controlling a telephone to communicate with a network via a data channel, and to sample and code audio signals or signals derived therefrom before providing them for transmission over the data channel.

A sixth aspect of the invention provides a method of operating an audio interface device, the method comprising controlling the device to provide a signal for controlling a telephone, preferably a mobile telephone, to communicate with a network via a data channel, controlling the device to sample and to code audio signals or signals derived therefrom and controlling the device to provide the coded signals for transmission over the data channel.

A seventh aspect of the invention provides a method of transmitting coded audio signals, the method comprising acts of controlling a mobile telephone to communicate with a network via a data channel, sampling audio signals, coding the samples or data derived from the samples, and providing the coded data for transmission over the data channel.

An eighth aspect of the invention provides a system comprising an audio interface device and a telephone, the audio interface device being operable to provide a control signal for controlling the telephone to communicate via a data channel, and to sample and code audio signals or signals derived therefrom before providing them to the telephone, the telephone being responsive to receiving the control signal for communication with a network via a data channel, and for transmitting the coded audio signals over the data channel.

The coding preferably is performed by a lossy compressor. This may be termed a compressor.

According to a ninth aspect of the invention, there is provided a method of communicating between first and second devices, the method comprising acts of, in a first device, encrypting a session key using an encryption key; sending the encrypted session key to the second device, in the second device, decrypting the encrypted session key, and using the session key to encrypt data transmitted in at least one direction between the first and second devices.

Preferably, the method comprises transmitting a further encrypted session key from one of the devices to the other device, and subsequently using the further session key to encrypt data transmitted in at least one direction between the first and second devices. In one embodiment, the encrypted session keys may be transmitted only in one direction between the devices, or they may be generated and sent by both devices on a shared basis.

For improved security, the method comprises periodically transmitting new encrypted session keys from the first device to the second device.

According to a tenth aspect of the invention, there is provided a communication device, comprising an encryption module that is adapted to encrypt a session key and is adapted to encrypt data with the session key, and a transmitter that is adapted to send the encrypted session key via a channel to another communication device and is adapted to send the encrypted data.

According to another embodiment, the transmitter is adapted to send a further encrypted session key, and wherein the encryption module is adapted to encrypt data using the further session key before sending the encrypted data.

Further preferably, for further improved security, the transmitter is configured to periodically transmit new encrypted session keys from the first device to the second device. According to another embodiment, the device is adapted to maintain a catalogue of session keys, the catalogue including a presently used session key and at least one unused session key. Here, the device may be adapted to periodically discard the session key being used for encrypting data, and may be adapted to subsequently use a new session key to encrypt data before sending the encrypted data.

Embodiments of the present invention are now described with reference to the accompanying drawings.

### BRIEF DESCRIPTION OF THE DRAWINGS

In the drawings:

FIG. 1 shows a system including various components according to the invention, and in which methods according to the invention are carried out; and

FIG. 2 is a schematic diagram of an audio interface device, in the form of a headset, forming part of the system of FIG. 1.

### DETAILED DESCRIPTION OF THE PREFERRED EMBODIMENT

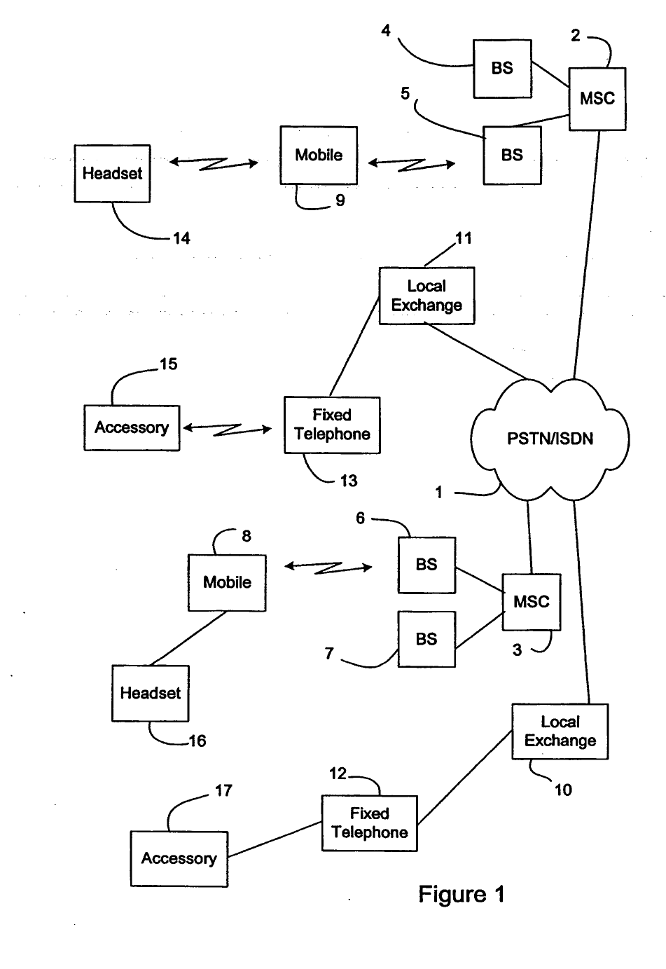

Referring to FIG. 1, a telecommunication system is shown centered around a telephone network 1. The telephone network 1 may be for example a public switched telephone network (PSTN) or an integrated services digital network (ISDN), although it may instead take any other form. The network 1 may comprise plural different networks connected together in any suitable fashion. Connected to the network 1 are first and second mobile switching centers (MSCs) 2, 3, which may or may not be operated by the same telecommunications services provider. To the first MSC 2 are connected first and second base stations (BSs) 4 and 5. The first MSC 2 and the first and second base stations 4 and 5 may operate for example according to the Global System for Mobiles (GSM) telephone system. A second mobile station 9 is in communication with the second BS 5, allowing calls to be made to and from telephones connected to the network 1. The second MSC 3 is connected to each of third and fourth base stations 6 and 7. The second MSC 3 and the third and fourth base stations 6 and 7 together form part of a telephone system operating according for example to the Universal Mobile Telephone System (UMTS) standard. A first mobile station 8 is in communication with the third base station 6, allowing calls to be made to and from other telephones connected to the network 1. Also connected to the network 1 are first and second local exchanges 10, 11, each of which are connected to many fixed telephones, although only a first telephone 12 is shown connected to the first local exchange and a second telephone 13 is shown connected to the second local exchange. The system comprises various other components which are not shown in FIG. 1 for conciseness. The first and second fixed telephones 12 and 13 are each provided with a data communication port, allowing the line between the telephone and the respective local exchange to be utilized to the transfer of data to and from the network 1. The first mobile telephone 8 is provided with an input whereby a hands-free handset can be connected, allowing the mobile telephone to be used in a hands-free way. The second mobile telephone 9 is provided with a Bluetooth transceiver, allowing communication with Bluetooth enabled devices in a wireless manner. The system thusfar described is conventional.

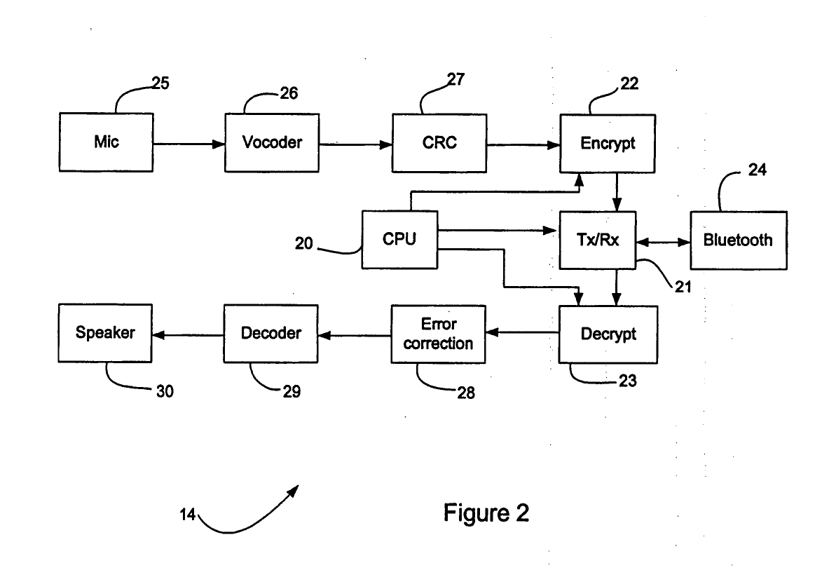

According to the invention, a first headset 14 is connected to the second mobile telephone by a Bluetooth link. The headset 14 is shown in more detail in FIG. 2, which is described below. An audio interface device 15 is associated with the second fixed telephone 13, and the two devices are connected by a wireless link, enabled by virtue of an infrared transceiver in the accessory 15 and by a corresponding infrared transceiver in the second fixed telephone 13. Connected to the first mobile telephone 8 is a headset 16, which includes a wired connection plugged into the hands-free connector of the mobile telephone. Similarly, an audio interface device 17, in the form of an accessory, is connected by a wire link to the data port of the first fixed telephone 12.

Referring now to FIG. 2, the headset 14 is shown comprising generally a central processing unit (CPU) 20, which is connected each of a data transceiver unit or modem 21, an encryption module 22 and a decryption module 23. The data transceiver unit or modem 21 is connected to a Bluetooth radio interface 24, whereby communication with the second mobile telephone 9 is enabled. The headset 14 includes a microphone 25, which is arranged to convert audio signals into digital electrical signals, which are then provided to a vocoder 26. The vocoder 26 is a conventional device, which is arranged to compress digitally the samples received at its input and to provide data signals at a fixed data rate at its output. The vocoder 26 may use any suitable algorithm, for example those known as the GSM, the G729 or Speex algorithms. Connected to the output of the vocoder 26 is an input of a cyclic redundancy check (CRC) addition module 27. The module 27 applies CRC bits to the data provided by the vocoder 26, which allow proper decoding of the vocoder output data at a remote location even if the data is partly corrupted before arriving. An output of the CRC module 27 is connected to an input of the encryption module 22, which operates in the manner described below. The microphone 25, the vocoder 26, the CRC module 27 and the encryption module 22 together form a speech input path, signals resulting from which can be transmitted to the second mobile telephone 9 under control of the CPU 20. A speech input path is constituted similarly by the decryption module 23, by an error correction module 28, a decoder 29 and a speaker 30. The error correction module 28 is connected to an output of the decryption module 23, and is operable to provide error correction on data received from the second mobile telephone 9 and decrypted by the decryption module. Error corrected data provided by the error correction module 28 is then decoded by a decoder module 29 to form audio samples. The samples are then converted into an analogue form before being provided as sound signals by the speaker 30. The headset 14 constitutes an audio interface device. Although the components are illustrated separately, they may be implemented in any conventional manner and may, for example, utilize a dedicated ASIC (application specific integrated circuit) or a common processor and a single physical memory. Alternatively, separate processors may be used for the vocoder 26 and the encryption module 22. These separate processors may also be used to effect the decoder 29 and the decryption module 23 respectively, or further separate processors may instead be used.

The accessory device 15 is similarly constructed to the headset 14, although the accessory device includes an infrared transceiver (not shown) in place of the Bluetooth transceiver 24. The headset 16 and the accessory device 17 are also similarly constructed, although no Bluetooth or infrared transceiver is present in these devices, and the transceiver or modem 21 may also be omitted, depending on the nature of the particular link used to connect to their respective telephone 8, 12.

Operation is as follows. When a user of the second mobile telephone 9 wants to instigate a telephone call with another telephone connected to the network 1, the user initially switches the headset 14 into an ‘on’ condition. This is detected by the second mobile telephone 9. To initiate secure communications, the user then simultaneously depresses volume increase and volume decrease switches (not shown) on the headset 14. This causes the headset 14 to send a control signal to the second mobile telephone 9 instructing it to enter either of a 9.6 and a 14.4 kbps (kilo bits per second) data mode. The control signal may be generated by a dedicated ASIC device, or may be integrated in an ASIC which forms the Bluetooth interface. In response to receiving the control signal, the CPU 20 prepares a data signal instructing the second mobile telephone 9 to open a data call with the base station 5, and the network 1, rather than opening a conventional voice channel. This is communicated to the telephone which is the recipient of the call, for example the second fixed telephone 13. A data call is then set up on a data channel between the mobile telephone 9 and the fixed telephone 13 in a conventional manner. Once the call is established, the headset 14, and in particular the CPU 20 thereof, controls the setting up of a 128 bit encryption key which is subsequently used for communications between the headset 14 and the accessory 15. This may occur in any convenient manner, but preferably involves the use of the Diffie-Hellman algorithm. This algorithm is well known in the art and is summarized at, for example, www.apocalypse.org/pub/u/seven/diffie.html.

When a user of the second mobile telephone 9 speaks, the audio speech signals are picked up by the microphone 25, where they are digitally sampled before being encoded by the vocoder 26. The coded speech data is then provided to the CRC module 27, where error correction data is added before the resulting data is encrypted by the encryption module 22 using the 128 bit encryption key. The manner of encryption is entirely conventional, and is carried out under control of the CPU 20. The encrypted data is then transmitted to the second mobile telephone 9 by way of the data transceiver or modem 21 and the Bluetooth transceiver 24, from where it is communicated over the network using the data call in progress. At the accessory 15, the encrypted data is received at its infrared transceiver (not shown), following which it is decrypted using the shared key, error correction is applied, the error corrected data is decoded and the speech finally reproduced. Similarly, when a user of the fixed telephone 13 speaks, the speech signals are converted into digital signals, then coded to reduce the amount of data, supplemented with CRC data and encrypted using the 128 bit encryption key. The encrypted data is then transferred from the fixed telephone 13 over the network 1 using the existing data call to the second mobile telephone 9. Encrypted data signals are then received by the Bluetooth transceiver 24 and the transceiver or modem 21, where they are decrypted by the decryption module 23. Data errors are then removed by the error correction module 28 before the resulting signals are decoded by the decoder 29 and finally the voice signals are reproduced at the speaker 30.

It will be seen that encryption and decryption is performed only at the headset 14 and the accessory 15, and that all communications therebetween are encrypted using the 128 bit encryption key. Accordingly, increased security is provided, since even if the call can be intercepted at any point between the mobile telephone 9 and the fixed telephone 13, the interceptor will have to decrypt the signals before being able to reproduce the audio signals. It will further be appreciated that the only special equipment required is the handset 14 and the accessory device 15.

An alternative embodiment will now be described, again with reference to FIGS. 1 and 2. This embodiment is much the same as that described above, although there are differences as regards the encryption of the sampled and coded audio signals. This further embodiment uses a simple form of session (stream) encryption. This type of encryption has a relatively short key length, for example 2999 bits. Coded voice data can be exchanged only after the first session key has been set up.

The exchange of coded voice data, as well as any other data, involves including the data into frames, which often is necessary to provide synchronization at both ends of the link. For simplicity, the headset (or other type of audio interface device) which is responsible for setting-up a session key is termed the key sending device, and the headset (or other type of audio interface device) which receives the key is termed the key receiving device. Instead of one device being the key sending device for the duration of a call, the devices may instead exchange responsibility one or more times during the length of a call.

In a preferred embodiment, the raw data provided by the vocoder 26 is produced at 8000 bits per second, and the overhead for the framing process uses about 1000 bits per second. In this example, the data channel used for communication has a capacity of 9600 bits per second, although other data rates may be used instead. With a 9600 bits per second channel being used, the 600 bits per second remaining are used to exchange new session keys. This involves a considerable signaling overhead—typically around 5000 bits are required to exchange a single session key of length 2999 bits. The new session keys are encrypted using the same RSA encryption used for the original session key exchange. The result is the exchange of a new session key every 9 seconds or so.

RSA encryption provides a good degree of security, although there is a significant amount of processing required to decrypt data which is RSA encrypted. If RSA encryption was used to encrypt the speech data, this processing needed for decryption would result in a lag in speech reproduction and in a significant current drain. Using RSA encryption with the session key transmission is advantageous since it provides RSA level security for the data but without the lag in speech reproduction and with only a proportion of the processor resource requirements.

The session keys are created by the key sending device from a Zener noise source, which is a genuinely random source, in a conventional manner.

The session keys are sent as segments with an index. Each segment contains a CRC (cyclic redundancy check) to allow errors to be detected. Segments with errors are discarded. The device receiving segments acknowledges every segment successfully received with a valid CRC. The device sending the segments resends any segment which has not been acknowledged. When all the segments for a session key have been received, the data is decrypted by the decryption module 23, and an embedded CRC for the entire key is checked by the error correction module 28. If the embedded CRC is deemed to be correct, the key is added to a catalogue of keys and an acknowledgement is sent to the key sending device. If the embedded CRC is determined to be faulty, the entire session key is discarded and no use is made of it. Following the successful or failed transmission of a session key, the next key is sent in the same manner.

Each headset maintains a catalogue of session keys. In a preferred example, the key in use is stored along with three other keys in the catalogue. Session keys are continually being exchanged using whatever spare bandwidth is available. When the session key sending device receives acknowledgment that the key has been added to the catalogue at the receiving device, it is also added to the catalogue at the sending device. The exchange of session keys stops only when the catalogue gets full, which in most cases is unlikely to occur. The purpose of the catalogue is to allow the communication channel to remain secure even when there are a few errors in the channel, which errors can slow the transmission of session keys since this would require the retransmission of more segments and is more likely to result in a key being rejected on the basis of the CRC check across the entire key.

When a key is discarded, the next key in the catalogue is used in its place. The key sending device instigates the signaling required to effect the change in the key being used to encrypt the data. The system aims to discontinue use of a key after a fixed period of time, for example ten seconds. However, this can be dynamically changed depending on the number of keys stored in the catalogue. For example, in good transmission conditions, it may be possible to discard each key after a shorter period of time. In bad conditions, using keys up at a rate of one every ten seconds may result in a condition where a key is ready to de discarded yet there are no unused keys present in the catalogue. To try to avoid this condition, the system preferably is able to detect the average time taken to transmit successfully a new key, and to set the key discard interval appropriately. Of course, it will usually be beneficial to have a greater inter-key interval for some time immediately after a call is set up, in order to at last partly fill the catalogue and thereby provide a buffer.

The CPU 20 of FIG. 2 is used to effect the RSA encryption of session keys and the encryption and decryption of data using the session keys. The catalogue is stored in a memory (not shown), which could be RAM or any other suitable memory type. The RSA encryption keys may be provided in any suitable way, as can the Zener noise source used by the key sending device to generate the session keys.

Conference calls are allowed for in a further embodiment of the application, which will now be described with reference to FIGS. 1 and 2. In this example, the mobile telephone 8 and the fixed telephone 13 are in communication with each other, with speech communication therebetween being encrypted and decrypted by suitable components of the associated accessory device 15 and headset 16. Supposing then that the user of the mobile telephone 8 wants to bring it into the call the first fixed telephone 12. The conference call is then set up in a conventional way, although the channel between the first fixed telephone 12 and the network, as with the first mobile telephone 8 and the fixed telephone 13, is a data call rather than a voice call. Once the channel between the mobile telephone 8 and the fixed telephone 12 is open, the headset 16 communicates with the accessory 17 associated with the fixed telephone 12 to provide it with the 128 bit key which is used to encrypt communications between the devices. Once the accessory device 17 is made aware of the encryption used, it is able to encrypt and decrypt signals in such a way that audio signals generated by the user of one of the telephones are reproduced properly at each of the other telephones.

It will be appreciated from the above that it is only the headset or accessory device associated with the telephone which is instigating a call which needs to provide a signal controlling its telephone to communicate with the network 1 via a data channel. All telephones which are being called or which are being joined on an existing call are automatically set up with a data channel.

Similarly, it is the headset or accessory associated with the telephone which instigates a call which is responsible for setting up the encryption key used to make secure communications between that telephone and the telephone being called. However, when a further telephone is introduced into a call so as to provide a conference call, it is the telephone which introduces the further telephone that is required to set up the encryption key with the newly joining telephone.

In a further embodiment, the RSA encryption of session keys generated at one device is used in a conference call environment. Here, it is the telephone which set up the call which is responsible for setting-up session keys, for RSA encrypting them and for sending them to the other telephones. In this case, it is necessary that each telephone correctly receives the keys. To facilitate this, it may be desirable to use greater inter-key intervals, shorter session keys or higher data rate channels.

It will be appreciated that the invention allows communication between users of two remote telephones to be securely encrypted, even though the only special equipment is the headset or accessory device which constitutes the audio interface at each end of the link. The telephones connected to the audio interface devices and all of the network in between the telephones may be entirely conventional.

Although the above embodiment utilizes the encoding of audio samples, this may not be necessary if a suitably high data rate data channel is available.

In an alternative embodiment, video pictures may also be encrypted before transmission. Here, a combined camera and display device (not shown) is connectable to a mobile telephone 8 via a Bluetooth interface. The camera device includes in series between a digital image production module and a Bluetooth transceiver an error correction bit addition module and an encryption module. In this way, images are encrypted with a secure key before transmission to the mobile telephone, following which they are transmitted to the network 1. The camera device may be used in conjunction with the headset 14, but preferably is combined therewith. In the combined case, the device is arranged to control the mobile telephone 8 to enter into communication with the network 1 using a General Packet Radio Service (GPRS) data channel. Also, a single Bluetooth interface is used to carry encrypted audio and video data to the mobile telephone 8, and the audio and video data is carried to the network over the GPRS data channel.

To reproduce encrypted video data, the combined camera and display device (not shown) is able to decrypt received encrypted video signals, to apply error correction and to display the result, preferably on a liquid crystal display (LCD). This allows full audio-visual communication bi-directionally between the combined camera and display device 14 and the network 1, and also so-called video-conferencing. Video conferencing may utilize three or more terminals joined on a call.

In the foregoing, the terms ‘data channel’ and ‘data call’ will be understood to refer to means for the transmission of data other than analogue voice channels or channels dedicated for the communication of voice signals. In GSM, voice calls as classed as “Teleservices”, and data calls are classed as “Bearer Services”. Teleservices includes the following audio call types: telephony, emergency calls, and voicemail, as well as some data call types, for example facsimile message 3. Bearer services include asynchronous and synchronous data, 300-9600 bps, alternate speech and data, 300-9600 bps, asynchronous PAD (packet-switched, packet assembler/disassembler) access, 300-9600 bps, and synchronous dedicated packet data access, 2400-9600 bps, which it will be appreciated can all be classed as ‘data calls’. A ‘data channel’ might be considered as one which is not designated for carrying voice communications or other audio signals, whether encoded or not, and a ‘data call’ might be considered as a call made over a data channel. The channel may be over GSM, 3G, CDMA-2000 or any other telephone network, either fixed or mobile. In a fixed telephone network, a data channel may be an ISDN, ADSL or ‘broadband’ data channel or sub-channel, for example.

What is claimed is:

1. An audio interface device operable to provide a signal for controlling a telephone to communicate with a network via a data channel, the device comprising:
a sampler that samples a received audio signal, and wherein the device is adapted to perform at least one of either encrypting and coding of at least one of the audio signal and one or more signals derived therefrom before providing them for transmission over the data channel.

2. A device as claimed in claim 1, further comprising a coder and an encrypter arranged to code and encrypt, respectively, the audio signal before providing them for transmission.

3. A device as claimed in claim 1, wherein the telephone is a mobile telephone.

4. A device as claimed in claim 1, further comprising a controller that adds error correction data to at least one of the audio signals or the signals derived therefrom before providing them for transmission.

5. A device as claimed in claim 1, wherein the device is adapted to perform encrypting using a Diffie-Hellman algorithm.

6. A device as claimed in claim 1, further comprising a receiver that receives encrypted signals from the telephone, and decrypts them before reproducing them as audio signals.

7. A device as claimed in claim 6, comprising a decoder that decodes the decrypted signals before reproduction.

8. A device as claimed in claim 6, wherein the receiver performs error correction on the decrypted signals.

9. A device as claimed in claim 1, wherein the device is adapted to encrypt a session key and transmit the encrypted session key over the data channel.

10. A device as claimed in claim 1, further comprising a sampler that samples a received video signal and an encrypts at least one of the received video signal and one or more signals derived therefrom before providing them for transmission over the data channel.

11. A method of operating an audio interface device, the method comprising acts of:
controlling the device to provide a signal for controlling a telephone to communicate with a network via a data channel;
controlling the device to sample and to perform at least one of either:
a) encrypting, and
b) coding audio signals or signals derived therefrom; and
controlling the device to provide the encrypted or coded signals, as the case may be, for transmission over the data channel.

12. A method of transmitting audio signals, the method comprising acts of:
controlling a mobile telephone to communicate with a network via a data channel;
sampling audio signals;
performing at least one of either:
a) encrypting, and
b) coding
the samples or data derived from the samples; and
providing the encrypted or encoded data, as the case may be, for transmission over the data channel.

13. A system comprising:
an audio interface device; and
a telephone, the audio interface device being operable to provide a control signal for controlling the telephone to communicate via a data channel, and to sample and either:
a) encrypt, or
b) code
audio signals or signals derived therefrom before providing them to the telephone, the telephone being responsive to receiving the control signal for communication with a network via a data channel, and being adapted to the encrypted or coded audio signals, as the case may be, over the data channel.

14. A method of communicating between first and second devices, the method comprising acts of:
in a first device, encrypting a session key using an encryption key;
sending the encrypted session key to the second device;
in the second device, decrypting the encrypted session key; and
using the session key to encrypt data transmitted in at least one direction between the first and second devices.

15. A method as claimed in claim 14, further comprising an act of transmitting a further encrypted session key from one of the devices to the other device, and subsequently using the further session key to encrypt data transmitted in at least one direction between the first and second devices.

16. A method as claimed in claim 14, further comprising an act of periodically transmitting new encrypted session keys from the first device to the second device.

17. A method as claimed in claim 14, further comprising an act of building a catalogue of session keys with each of the first and second devices, each catalogue including a presently used session key and at least one unused session key.

18. A method as claimed in claim 17, further comprising an act of periodically discarding the session key being used for encrypting data, and subsequently using a new session key to encrypt data transmitted in the at least one direction.

19. A method as claimed in claim 14, further comprising an act of randomly generating the session key or keys.

20. A method as claimed in claim 14, further comprising an act of encrypting the session key or keys using RSA encryption.

21. A communication device, comprising:
an encryption module that is adapted to encrypt a session key and is adapted to encrypt data with the session key; and
a transmitter that is adapted to send the encrypted session key via a channel to another communication device and is adapted to send the encrypted data.

22. A device as claimed in claim 21, wherein the transmitter is adapted to send a further encrypted session key, and wherein the encryption module is adapted to encrypt data using the further session key before sending the encrypted data.

23. A device as claimed in claim 21, wherein the transmitter is configured to periodically transmit new encrypted session keys from the first device to the second device.

24. A device as claimed in claim 21, wherein the device is adapted to maintain a catalogue of session keys, the catalogue including a presently used session key and at least one unused session key.

25. A device as claimed in claim 24, wherein the device is adapted to periodically discard the session key being used for encrypting data, and is adapted to subsequently use a new session key to encrypt data before sending the encrypted data.
